(19) United States
(12) Patent Application Publication
(10) Pub. No.: US 2018/0105157 A1
(43) Pub. Date: Apr. 19, 2018

(54) SYSTEM AND METHOD FOR CONTROLLING ELECTRIFIED VEHICLES

(71) Applicant: Ford Global Technologies, LLC, Dearborn, MI (US)

(72) Inventors: Jiyao WANG, Canton, MI (US); Wei XU, Canton, MI (US)

(21) Appl. No.: 15/293,340

(22) Filed: Oct. 14, 2016

(51) Int. Cl. B60W 20/10; B60W 10/08; B60W 10/26; B60L 11/08

(52) U.S. Cl. CPC B60W 20/10; B60W 10/08; B60W 10/26; Y10S 903/907; B60W 2710/083; Y10S 903/906; B60L 11/08

(57) ABSTRACT

A hybrid vehicle may include a battery coupled to a converter to provide power to a generator and motor via the converter, and a controller programmed to select one of a battery voltage supplied by the battery and an boosted or updated voltage converted by the converter to meet a torque demand of the generator or motor and having the lower energy loss associated therewith, wherein the boosted voltage is iteratively selected to minimize energy loss.

### TECHNICAL FIELD

This disclosure relates to systems and methods for controlling electrified vehicles such as hybrid electric vehicles.

### BACKGROUND

Hybrid Electric Vehicles (HEVs) often use a power split architecture to combine combustion torque created by the engine and the electric torque generated by two electric machines to drive the vehicle. The electrical machines may operate as a generator and/or a motor. A voltage demand by the generator and motor may require a higher voltage on the DC-bus than that of the battery, thus requiring a variable voltage converter (VVC) to increase the voltage from the battery.

### SUMMARY

A powertrain system may include a motor and a generator, each having a torque demand, a battery providing a battery voltage to a converter, and a controller configured to: select a converter operating voltage lower than a motor or generator voltage associated with maximum torque-per-amp to meet the torque demands to decrease energy loss at the converter, the operating voltage being a selected one of the battery voltage with the converter operating in pass-through mode, and a new voltage with the converter operating in boost mode, the new voltage iteratively calculated to meet the torque demands and decrease converter energy loss over that of the converter supplying the MTPA voltage in boost mode.

A method for reducing energy loss of electric vehicles may include calculating a first loss as a result of a converter operating in a pass-through mode using a battery voltage and an increased motor current, iteratively selecting a new voltage, calculating a second loss as a result of the converter operating in boost mode with the new voltage, and selecting the voltage with the lower loss.

A hybrid-vehicle may include a battery coupled to a converter to provide power to a generator and motor via a converter, and a controller programmed to select one of a battery voltage supplied by the battery and an updated voltage converted by the converter to meet a torque demand of the generator or motor and having the lower energy loss associated therewith, wherein the updated voltage is iteratively selected to minimize energy loss.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a system diagram of a powertrain system for hybrid electric vehicles;

FIGS. 2A-2B illustrate a flow chart for a process of the powertrain system;

FIG. 3A illustrates an example chart showing total energy loss vs. DC-bus voltage the example where a VVC is in a pass-through mode and maximum torque-per-amp (MTPA) is achieved;

FIG. 3B illustrates an example chart showing total energy loss vs. DC-bus voltage the example where a VVC is in a pass-through mode and MTPA is not achieved; and

FIG. 3C illustrates an example chart showing total energy loss vs. DC-bus voltage the example where a VVC is in a boost mode.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Hybrid Electric Vehicles (HEVs) that use a power split architecture may recognize a voltage demand from the generator and motor. This voltage demand may require a higher voltage on the DC-bus than that of the battery, thus requiring a variable voltage converter (VVC) to increase the voltage from the battery. This may cause the VVC to operate in a boost mode, which may lead to higher power loss. Disclosed herein is a powertrain system configured to meet the voltage demands of the generator and motor, while decreasing the situations in which the VVC is operating in boost mode. To the extent that the VVC may operate in boost mode, a lower voltage may be selected that will lower the losses over those generated when using the required voltage.

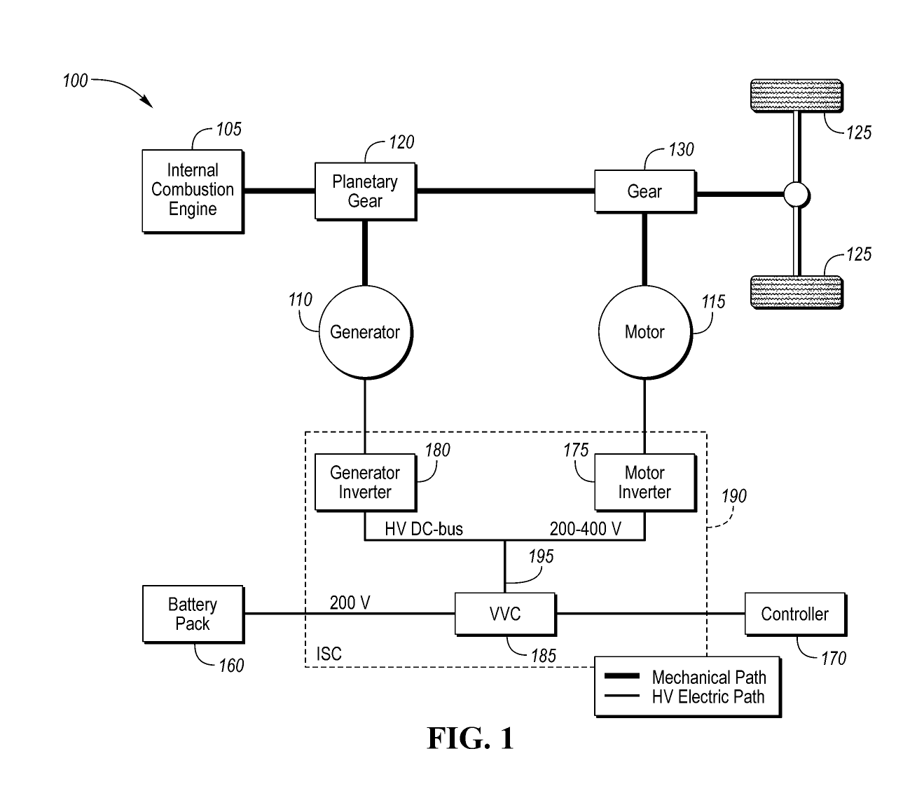

FIG. 1 illustrates a system diagram of a powertrain 100 of a hybrid electric vehicle (HEV) (not shown). The powertrain 100 may include a power split system for combining the combustion torque generated by an engine 105 and the electrical torque generated by a motor 115 and a generator 110. The motor 115 and the generator 110 may be electric machines being permanent-magnetic AC motors with three-phase current inputs. The engine 105 and the generator 110 may be connected by a planetary gear set 120. The motor 115 may be connected to the planetary gear set 120 and the vehicle wheels 125 by a motor gear set 130. The motor 115 may be connected to a drive shaft 165 on the vehicle such that the drive shaft may transmit torque from the motor 115 and/or the engine 105 to the wheels of the vehicle.

The system 100 may include a controller 170, such as a Motor Generator Control Unit (MGCU), in communication with a generator inverter 175 and a motor inverter 180. The controller 170 may include input communication channels and output communication channels and may control the inverters 175, 180 to drive the motor 115 and/or generator 110 at desired torques. The inverters 175, 180 may be interfaced directly to a high-voltage battery pack 160 of the vehicle or through a variable voltage converter (VVC) 185. The controller 170 may be a computer configured to perform the processes disclosed herein via control logic. The controller 170 may be coupled to a memory or database (not shown). The controller 170, and/or memory thereof, may produce and maintain motor and generator values.

The VVC 185, motor inverter 175, and generator inverter 180 may be part of an inverter system controller (ISC) system 190. The inverters 175, 180 may connect directly to an HV DC-bus 195 arranged between the inverters 175, 180 and the VVC 185. The inverters 175, 180 are capable of operating the generator 110 and motor 115 at their maximum torque per amp (MTPA) condition. The MTPA condition may result in minimum electric loss of the motor 115 and generator 110.

The VVC 185 may operate in various modes to control the voltage supplied to the inverters 175, 180. For example, the VVC 185 may operate in a pass-through mode. During the pass-through mode, the power electronics are not switching, thus eliminating switching losses. The battery pack 160 may be directly or indirectly connected through the VVC to the HV DC-bus 185 and the HV DC-bus voltage is equal or near equal to that of the battery voltage from the battery pack 160.

The VVC 185 may also operate in a boost mode. During the boost mode, the HV DC-bus 195 may be controlled by the VVC 185. In this situation, the HV DC-bus 195 may have a higher voltage than that of the battery pack. The boost mode allows the VVC 185 to boost the battery pack voltage (e.g., 200 V) to a desired DC-bus voltage (e.g., 200 to 400C) so that both the generator 110 and the motor 115 can achieve their MTPA. Thus, when the required DC-bus voltage exceeds the battery pack voltage, the VVC 185 operates in boost mode. This requirement causes the VVC 185 to operate in boost mode under most conditions.

However, during the boost mode, the system 100 recognizes a greater energy loss than it would compared to when operating in pass-through mode. This may be in part due to the fact that the VVC 185 itself consumes energy. Further, a higher DC-bus voltage may lead to higher ISC loss, specifically, switching loss of power electronics in the ISC. In an effort to optimize the system 100, consideration may be given to the electrical loss from the VVC 185 and inverters 175, 180, in addition to the generator 110 and motor 115.

During certain conditions, the boost mode leads to non-optimal operation of the system 100. For example, when the motor speed is high with zero torque, and when the generator speed is medium with high torque, the motor requests a high DC-bus voltage and thus the VVC 185 operates in boost mode 185. Even though the generator 110 is requesting a DC-bus voltage that does not require the VVC 185 to operate in boost mode, the motor 115 is requesting a DC-bus voltage that does. This, however, will induce VVC loss and thus may cause extra energy loss within the system 100 and reduction of vehicle energy efficiency or fuel economy.

The controller 170, however, may select a voltage to reduce overall system energy loss by permitting the VVC 185 to operate in the pass-through mode during more conditions, and/or by permitting the VVC 185 to operate in the boost mode at a lower voltage than the otherwise required or requested voltage. For example, the controller 170 may calculate or evaluate two voltages. The first voltage may be the battery voltage capable of achieving the torque demands of the motor and/or generator. The second voltage may be an iteratively updated voltage configured to have a lower total energy loss than that of the required voltage. The second voltage may be the lowest voltage at which the torque demands may be met, while having a lower total energy loss than that of the required voltage.

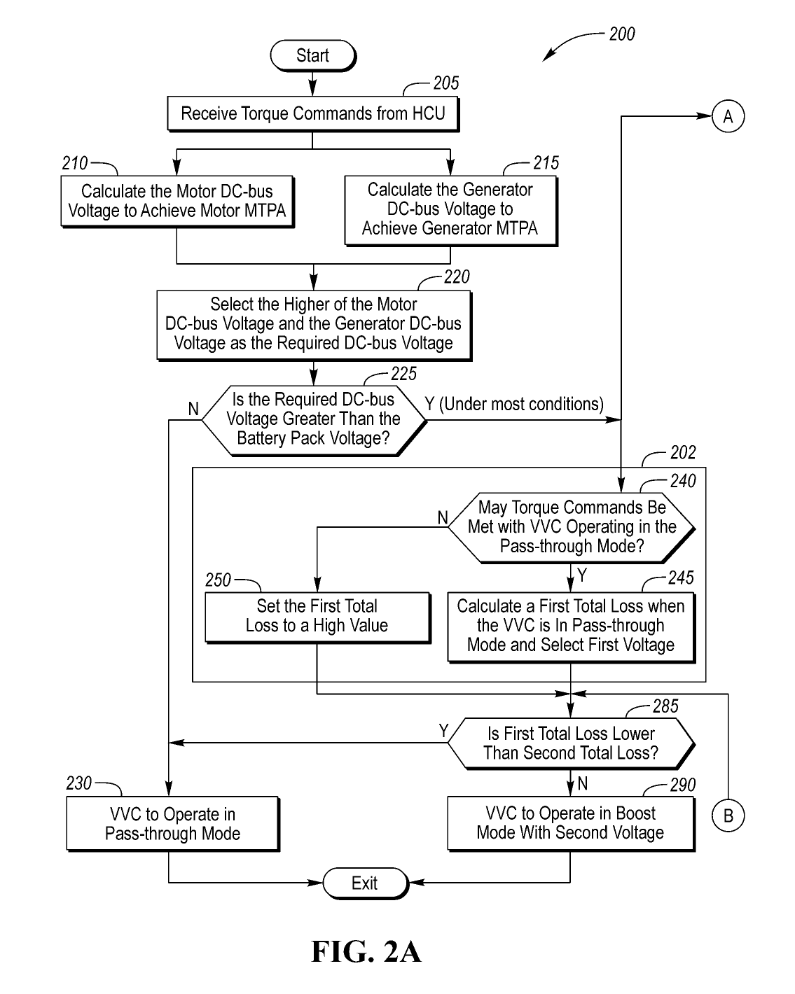

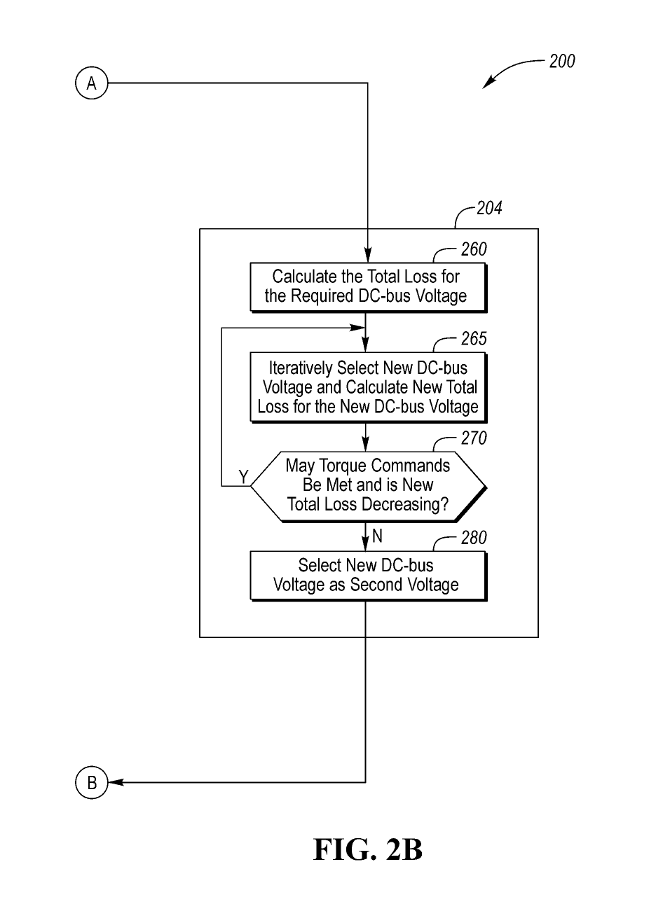

The controller 170 may compare the total energy losses of the first voltage with that of the second voltage and select the voltage with the lowest energy loss as the designated or currently determined optimal voltage. In the event that the battery voltage may not be capable of meeting the torque demands in the pass-through mode, the second voltage may be substantially lower than the requested or required voltage (e.g., from block 220 discussed below) and thus decrease the energy loss. That is, even if the torque requirements do not facilitate operation of the VVC 185 in the pass-through mode, the VVC 185 may be operated in the boost mode using a lower requested voltage, and therefore lower loss. This process is described in more detail below with respect to FIGS. 2A-B.

FIGS. 2A-B illustrate a flow chart for a process 200 of the powertrain system 100. The process 200 may select a voltage to reduce the amount of time that the VVC 185 operates in the boost mode. The selected VVC operating voltage may be selected from one of a first voltage established in a first sub-process 202, and a second voltage, established in a second sub-process 204. The voltage capable of producing the lower amount of system energy loss may be selected as the VVC boost mode operating voltage.

The process 200 may begin at block 205 where the controller 170 may receive torque demands from the hybrid control unit (HCU) (not shown.) The torque demands may include a desired torque for each of the generator 110 and the motor 115.

At block 210 the controller 170 may calculate the motor DC-bus voltage to achieve motor MTPA. Concurrently, or near concurrently, at block 215, the controller 170 may calculate the generator DC-bus voltage to achieve generator MTPA. The DC-bus voltages may be calculated from a calibration map, stored in a memory of the controller 170.

At block 220, the controller 170 may be configured to select the higher of the motor DC-bus voltage and the generator DC-bus voltage, as calculated in blocks 210 and 215, respectively. This voltage may be the requested or required voltage to meet MTPAs and torque demands of both motor and generator.

At block 225, the controller 170 may determine whether the required DC-bus voltage exceeds the battery pack voltage. In other words, is the battery voltage sufficient to meet MTPA. In one example the battery voltage may be 200 V. If the DC-bus voltage is 250 V to achieve MTPA, the DC-bus voltage is greater than the battery pack voltage. However, if the MTPA DC-bus voltage does not exceed the battery pack voltage, the process 200 proceeds to block 230.

At block 230, the controller 170 instructs the VVC 185 to operate in the pass-through mode. In this example, the required MTPA DC-bus voltage may be relatively low and thus the battery pack voltage may be sufficient to achieve MTPA of both the generator 110 and the motor 115. The VVC 185 may operate in the pass-through mode and thus VVC losses are low. The process 200 may then end.

If, at block 225, the required DC-bus voltage exceeds the battery pack voltage, the process 200 proceeds to blocks 240 and 260. Block 240 initiates a first sub-process 202 configured to calculate a first DC-bus voltage. Block 260 initiates a second sub-process 204 configured to calculate a second DC-bus voltage.

Within the first sub-process 202, at block 240, the controller 170 examines whether the torque demands may be met with the VVC 185 operating in the pass-through mode. In the pass-through mode, the DC-bus voltage is equal to the battery voltage. The battery voltage may not be sufficient for the motor and generator to deliver the requested torque(s). However, the torque demands must be achieved regardless of the total loss. In the case that the torque demands cannot be met, the DC-bus voltage must be increased and thus the VVC operates in the boost mode. That is, at block 240, the controller examines whether the torque demand may be achieved without meeting MTPA.

For example, if the battery voltage is 200 V, the torque demands may be met, but the MTPA may not. Any voltage higher than the required MTPA DC-bus voltage, e.g., 250 V, will guarantee MTPA. Any voltage lower than the required MTPA DC-bus voltage will not guarantee MTPA. The motor may achieve the torque demand with an increased motor current. However, the DC-bus voltage cannot be too low, otherwise the motor will fail to produce the torque demand even with the increased motor current. If the torque demands may be met in the pass-through mode, the process 200 proceeds to block 245. If not, the process proceeds to block 250.

At block 245, the controller 170 calculates a first total loss when the VVC 185 is operating in the pass-through mode. The first total loss may include the total energy loss of the VVC 185 during pass-through, as well as the motor loss, including loss attributable to the increased motor current, generator loss, motor inverter loss and generator inverter loss.

At block 250, in response to the torque demands exceeding the available torque from operation of the VVC 185 in the pass-through mode, the controller 170 may set a total loss to a high value to disable the VVC 185 from operating in the pass-through mode. This value may be an exceptionally high value such as 100 times higher than a normal value. For example, the value may be set at 100 kW. In this example, the VVC 185 may not be capable of meeting the required motor and generator torque demands and to avoid selection of the first voltage, the calculated total loss is intentionally set high, thus forcing the system to operate in the boost mode at block 285.

Within the second sub-process 204, at block 260, the controller 170 calculates the total loss for the required DC-bus voltage. The total loss may include the total energy loss of the ISC 190 as well as the motor 115 and the generator 110 expected to be realized in order to achieve the required MTPA DC-bus voltage.

At block 265, the controller 170 may select a new DC-bus operating voltage and re-calculate a new total loss for the new DC-bus operating voltage. The controller 170 may iteratively select new DC-bus operating voltages until one is selected that is capable of meeting the torque demands, as well as decreasing the total loss, as compared to that calculated in block 260.

At block 270, the controller 170 may examine whether the torque demands may be met with the new DC-bus voltage. If the torque demands may be met, the controller 170 may examine whether the new total loss decreases over that of the loss of the most recent DC-bus voltage. That is, the controller 170 iteratively calculates or selects new DC-bus voltages. If the total system loss of the most recent DC-bus voltage is less than that of the previous iteration, the process 200 proceeds to block 265 in an attempt to select a voltage that provides for even lower losses. If the overall system loss of the new DC-bus voltage ceases to decline, then the controller 170 may recognize that the voltage with the lowest loss associated therewith has been identified and the process 200 proceeds to block 280.

At block 280, the controller 170 may select the new DC-bus voltage as the second DC-bus voltage. Such second voltage may be the lowest voltage that is capable of meeting the torque demands of the generator 110 and the motor 115, allowing for a decreased total energy loss. The new total energy loss may be selected as the second total loss for the second sub-process 204. The second total loss may include the total energy loss of the VVC 185 during boost mode, as well as the motor loss, generator loss, motor inverter loss and generator inverter loss. Unlike the first loss, the second loss does not include the additional motor loss attributable to the increased motor current required to meet the torque requirement.

At block 285, the controller 170 may compare the calculated total losses associated with the voltages from the first sub-process 202 and the second sub-process 204. That is, the controller 170 may compare the first total loss from block 245 with the second total loss from block 265. The controller 170 may examine whether the first total loss is lower than the second total loss. If the first total loss is lower than the second total loss, the controller 170 may select the first DC-bus voltage as an optimal voltage and the process 200 proceeds to block 230. In this example, the total system loss is a trade-off between motor/generator field weakening loss and VVC 185 loss. While the VVC 185 is in pass-through mode, the DC-bus voltage may not be sufficient to achieve MTPA. The motor/generator may operate in a field weakening region with increased energy loss, specifically copper loss. However, the VVC 185 does not induce any further energy loss, such as switching loss, in this operating mode.

If the first total loss exceeds the second total loss, the process 200 proceeds to block 290. At block 290, the controller 170 may instruct the VVC 185 to operate in the boost mode to achieve the new DC-bus voltage selected at block 265. In this case, the controller 170 may select the second DC-voltage as the operating voltage. Although the VVC 185 may not operate in the pass-through mode, the total loss may be less than if the selected DC-bus voltage selected in block 220 was used as the operating voltage. As explained, in this example, the total system loss is a trade-off between motor/generator field weakening loss and ISC switching loss. By iteratively calculating the new DC-bus voltage and comparing the total energy loss associated with the new DC-bus voltage with that of the currently selected DC-bus voltage, an operating voltage may be selected to achieve the torque demands while decreasing the total system loss. The process then ends.

The above process reduces or minimizes the total electric energy loss in the electric system of the HEV. In one example, when the motor 115 is at a high speed with a low or zero torque demand, and when the generator 110 is at a medium speed with a high torque demand, the VVC 185 may operate in the pass-through mode by field weakening the motor 115. This is in part due to the fact that the motor 115 will not request a high DC-bus voltage and the VVC can operate in pass-through mode. While the motor loss may increase slightly, the overall system loss may be reduced.

While process 200 is described as being performed by the controller 170, the process 200 may be performed by another control unit or processor either embodied within the vehicle or remote from the vehicle.

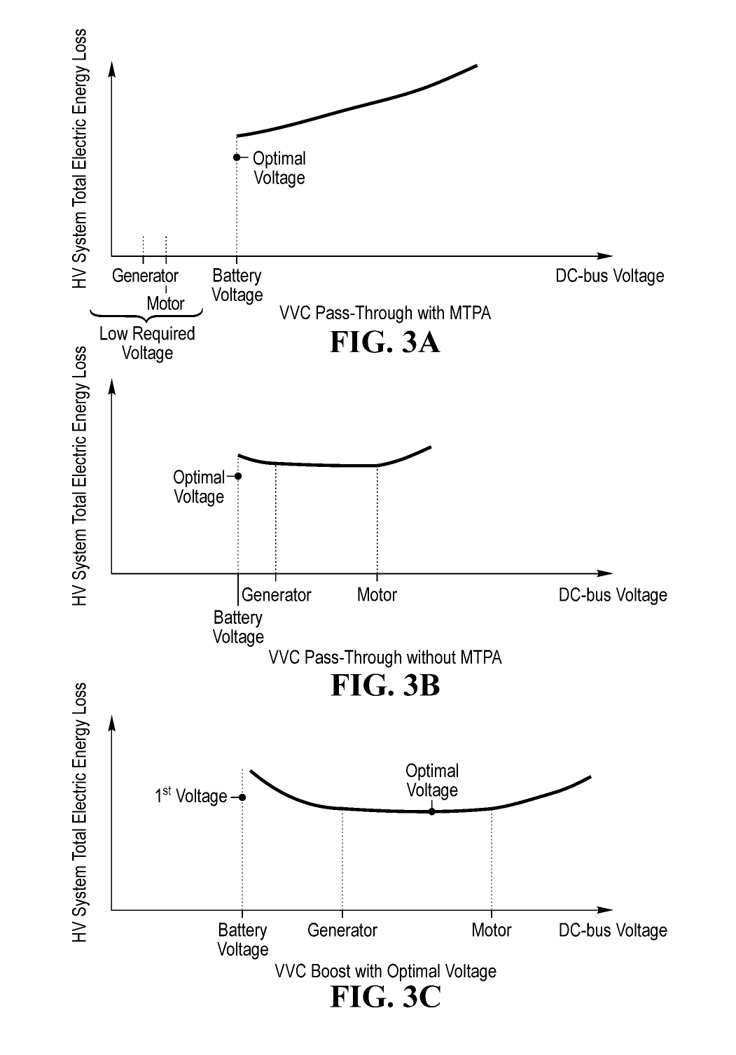

FIGS. 3A-C illustrate example charts showing total energy loss vs. DC-bus voltage. For example purposes only, FIGS. 3A-C illustrate a situation where the motor 115 requires a higher DC-voltage than the generator 110. FIG. 3A illustrates the example where the VVC 185 is in the pass-through mode and MTPA is achieved. In this example, the generator and motor both require a voltage lower than the battery pack voltage, which is approximately 200 V. The selected DC-bus operating voltage may be lower than the battery pack voltage. As is evident from FIG. 3A, as the DC-bus voltage increases, so does the electric energy loss.

FIG. 3B illustrates an example with the VVC 185 operating in the pass-through mode without MTPA being achieved. In this example, the selected operating voltage is lower than the required MTPA DC-bus voltage from block 220 of FIG. 2. The generator 110 and motor 115 each may have calculated DC-bus voltages that are higher than the voltage that reduces or minimizes total system energy losses. Thus, the system 100 may recognize lower energy losses due to the selected lower DC-bus voltage.

FIG. 3C illustrates an example with the VVC 185 operating in the boost mode. In this mode, the first DC-bus voltage as calculated in the first sub-process 202 may be greater than the second DC-bus voltage as calculated in the second sub-process 204. Thus, even though the VVC 185 may be operating in the boost mode, the operating voltage is lower than that of the calculated MTPA DC-bus voltage.

Accordingly, described herein is a powertrain system for reducing the amount of time that the VVC operates in the boost mode, thus decreasing the energy loss attributable to the VVC. Further, in the case that the VVC operates in the boost mode, an operating voltage is selected that has a lower total energy loss than that of the originally required DC-bus voltage to obtain MTPA and deliver the demanded torque(s). Accordingly, a higher efficiency, lower loss system is achieved.

Computing devices such as the controllers described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, Matlab Simulink, TargetLink, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, EEPROM (Electrically Erasable Programmable Read-Only Memory and is a type of non-volatile memory used in computers and other electronic devices to store small amounts of data that must be saved when power is removed, e.g., calibration tables or device configuration.) optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein.

While representative embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments that may not be explicitly illustrated or described.

What is claimed is:

1. A powertrain system, comprising:
a motor having a motor torque demand and a generator having a generator torque demand;
a battery providing a battery voltage to a converter; and
a controller configured to:
select an operating voltage to meet the higher of the motor torque demand and the generator torque demand and decrease energy loss at the converter, the operating voltage being selected from the battery voltage with the converter operating in pass-through mode, and a boost voltage with the converter operating in boost mode, the boost voltage iteratively calculated to meet the higher torque demand and decrease energy loss over that of the converter supplying an operating voltage associated with a motor or generator maximum torque-per-amp voltage in the boost mode.

2. The system of claim 1, wherein the controller is further configured to calculate a first loss associated with the converter operating in the pass-through mode and supplying the battery voltage.

3. The system of claim 2, wherein the controller is further configured to calculate a second loss associated with the converter operating in the boost mode and providing the boost voltage.

4. The system of claim 3, wherein the controller is configured to select the operating voltage associated with the lower of the first loss and the second loss.

5. The system of claim 2, wherein the first loss includes energy loss attributable to at least a motor loss and a generator loss, the motor loss including a loss caused by an increased motor current supplied to the motor to meet the motor torque demand.

6. The system of claim 3, wherein the second loss includes energy loss attributable to at least a motor loss and a generator loss.

7. The system of claim 1, wherein the operating voltage is iteratively selected from a plurality of voltages and is the lowest voltage of the plurality of voltages capable of achieving the higher torque demand with a lowest loss.

8. A method for controlling a vehicle having a battery, a generator, and a motor coupled by a bus, comprising:
controlling a voltage converter to operate in either a pass-through mode at battery voltage or a boost mode at a boost voltage higher than battery voltage to provide a requested motor or generator torque, the boost voltage selected to minimize total energy loss associated with the voltage converter, the motor, and the generator.

9. The method of claim 8, further comprising controlling the voltage converter to operate in the boost mode when the battery voltage is insufficient to provide the requested motor or generator torque.

10. The method of claim 8, further comprising controlling the voltage converter to operate in the pass-through mode in response to the total loss associated with operating in the boost mode exceeding the total loss associated with operating in the pass-through mode.

11. The method of claim 8, further comprising iteratively calculating the total loss associated with operating the voltage converter in the boost mode at each of a plurality of boost voltages to minimize the total energy loss.

12. The method of claim 8, wherein the boost voltage is iteratively selected from a plurality of voltages and is the lowest voltage of the plurality of voltages capable of achieving the requested motor or generator torque.

13. The method of claim 8, further comprising controlling the converter to operate in the boost mode in response to the requested motor or generator torque exceeding motor or generator torque produced by applying the battery voltage when operating the voltage converter in the pass-through mode.

14. The method of claim 13, wherein the motor loss includes a loss caused by an increased motor current supplied to the motor to meet the requested motor torque.

15. A hybrid vehicle, comprising:
a battery coupled to a converter to provide power to a generator and motor via the converter, and
a controller programmed to select one of a battery voltage supplied by the battery and an updated voltage supplied by the converter to meet a torque demand of the generator or motor, the selected voltage based on a lower energy loss associated therewith, wherein the updated voltage is iteratively selected to minimize energy loss.

16. The vehicle of claim 15, wherein the converter is configured to operate in one of a pass-through mode and a boost mode based on a voltage required to achieve maximum torque per amp (MTPA).

17. The vehicle of claim 16, wherein the controller is configured to select one of the battery voltage and updated voltage in response to the battery voltage failing to achieve MTPA.

18. The vehicle of claim 15, wherein the controller is configured to instruct the converter to operate in pass-through mode using the battery voltage in response to the torque demand being capable of being achieved with an increased motor current.

19. The vehicle of claim 15, wherein the controller is configured to instruct the converter to operate in boost mode with the updated voltage in response to the torque demand not being capable of being achieved with an increased motor current.

20. The vehicle of claim 15, wherein the updated voltage is iteratively selected from a plurality of voltages and is the lowest voltage of the plurality of voltages capable of achieving the torque demand with a lowest loss.
